(19) United States
(12) Patent Application Publication
(10) Pub. No.: US 2007/0277322 A1
(43) Pub. Date: Dec. 6, 2007

(54) Method and apparatus for use by a patient in temporarily lifting that person with respect to a horizontal surface--such as a bed

(76) Inventor: Jonathan E. Pastusek, Fort Worth, TX (US)

Correspondence Address: Mr. Charles W. McHugh, 1010 Milby Road, Arlington, TX, 76013, US

(21) Appl. No.: 11/357,838

(22) Filed: Feb. 16, 2006

(51) Int. Cl. A61G 7/10

(52) U.S. Cl. 5/662

(57) ABSTRACT

A support for a trapeze or other structure (such as a sling) that depends from a rail, said rail extending over a bed (usually a hospital bed) or other patient-support device. A carriage (which might be called a trolley) is provided for selective movement along a conventional rail, from one end to the other. Alternatively, the carriage is held static, where it provides a stable “anchor” for a trapeze and the person who is pulling downward on the trapeze. The static condition is initiated by the action of pulling downward on the trapeze, causing the carriage to bear against the rail with what may best be described as a “gripping” action. Switching between free movement along the rail and braked movement is automatic, and involves only a downwardly directed force on the carriage, which force may be supplied by an attending nurse or the patient.

### FIELD OF THE INVENTION

This invention relates generally to the temporary lifting of a person with respect to a horizontal surface—such a bed on which the person may be reclining; more particularly, it relates to an improved manner of permitting a person to use his or her own strength to rise, temporarily, from a generally prone position to an alternate position.

### BACKGROUND OF THE INVENTION

It is common for persons who are seriously ill or have been involved in a serious accident or the like to be restricted to a hospital bed for an extended period of time. Eventually, as they begin to recover from the effects of their illness or accident, they begin to feel restless and they want to change their position with respect to the supporting bed. In a typical hospital environment, when sliding over a bed sheet doesn't provide a satisfying change in position, it is possible to take advantage of the hardware that is present in many hospitals, namely, a structural rail that extends longitudinally over a bed, usually a few feet above the bed. Such a structural arrangement is shown in U.S. Pat. No. 4,551,872 to Reed entitled “Orthopedic Traction Frame,” in which an octagon-shaped rail 34 extends from one end of the bed to the other end. Depending from the rail 34 is a supporting structure commonly called a “trapeze” that is suspended from the rail at a height so that it can be grasped by a patient who is reclining on the bed. Pulling downward on the handle portion of the Reed trapeze 72 allows a patient to lift himself or herself off the top surface of the bed for a sufficient distance as to allow a change in relative position between the patient and the bed. (For convenience, the male gender will be used hereinafter in a generic sense, to refer to both men and women.)

Another style of rail clamp is shown in FIG. 1 of U.S. Pat. No. 4,593,422 Wolpert, Jr. et al. entitled “Telescoping Wing Nut Clamping Unit.” Still another style of rail clamp is shown in U.S. Pat. No. 5,836,026 to Reed entitled “Orthopedic Trapeze With Self-Locking Rotatable Mechanism.”

A couple of safety considerations need to be kept in mind when evaluating the relationship between a typical trapeze and the supporting rail over a bed. First, the trapeze needs to be held in a static manner—at least during the time when a patient is pulling downward on the trapeze handle, or else the trapeze might slip or even move a short distance horizontally along the rail. This could cause the patient to lose his or her balance during the course of attempting a lifting maneuver. To avoid this, a rigid clamp of some kind is routinely held firmly to the rail, and the clamp is not movable except by someone who has whatever tools may be necessary to loosen a bolt or the like. The person who “frees” the clamp and allows the trapeze to move longitudinally along the rail is sometimes a mechanic or other “technical” person, or it can be an attending nurse with more skill in patient care than in machinery. Second, the trapeze needs to be readily adjustable in position along the rail, so that its relative position can be optimized for each patient who may someday be using the bed. Such movement along the rail may include movement to one or the other of the two ends of the rail; or it may include complete removal of the clamp, so that the trapeze can be moved out of the way of an attending physician, nurse or other care-giver. In both of these situations, the patient is usually denied the opportunity to make personal adjustments in the physical location of the trapeze along the rail. It is an object of this invention to address both of these situations, and to do so without introducing any new problem involving patient care and rehabilitation.

### BRIEF DESCRIPTION OF THE INVENTION

In brief, the invention disclosed herein involves a two-stage support for a trapeze or other structure (such as a sling) that depends from a rail, said rail extending over a bed (usually a hospital bed) or other patient-support device. In the first stage of operation, a carriage is provided that permits free and unobstructed movement of the carriage along a conventional rail, from one end to the other. A variety of constructions for the proposed carriage are disclosed, some of which include wheels that bear against the top of the rail to provide low-friction contact with the rail. Other constructions omit wheels but rely strictly on geometry to foster relative movement between the carriage and the rail—when it is desired. In the second stage of operation, the carriage is held static, such that it provides a stable “anchor” for a trapeze and the person who is pulling downward on the trapeze. This second stage of operation is initiated by the action of pulling downward on the trapeze, causing the carriage to bear against the rail with what may best be described as a “gripping” action. The switching between free movement along the rail and braked movement is automatic, and involves only a downwardly directed force on the carriage, which force may be supplied by an attending nurse—or the patient who is to be the beneficiary of any vertical movement with respect to the horizontal bed. By allowing the patient to control the location and use of the trapeze, there will be less likelihood of imposing an extra burden on a busy nurse or other care-giver. That is, a restless patient who never seems to be satisfied and/or comfortable, and who is always wanting to accomplish a change in body position, can perhaps accomplish those desired changes without demanding help from anyone else.

In its most elemental terms, the invention may be described as having utility in an environment that includes a structural rail that is mounted securely over a bed in which a person may be resting in a generally prone position. Additionally, there is present a carriage (which might also be called a trolley) that is adapted for selective movement to any one of a variety of positions along the elongated rail. There is also a structural member that hangs downwardly from the carriage toward the bed. A condition is first established in which the carriage is freely movable along the rail in response to a modest manual force on the carriage in a longitudinal direction. By the expression “modest manual force” it is meant the force that can routinely be applied by a person's finger or maybe a couple of fingers. A second condition is then established in which the carriage is held static with respect to the rail. The carriage will then function as an anchor to support a person who is pulling downwardly on the structural member. The change between the first and the second condition is effected by a downward force that is generally perpendicular to the rail. This downward force can be supplied by, for example, a patient who is lying on a bed below the rail and pulls downwardly on the trapeze. Alternatively, a cable may be attached at its upper end to the carriage and used to selectively release a brake that is mounted on the carriage, said brake being normally applied to the rail to hold the carriage static.

### BRIEF DESCRIPTION OF THE FIGURES OF THE DRAWING

FIG. 1 is a perspective view of a typical hospital bed with a structural rail positioned above the bed;

FIG. 2 is a perspective view of the same kind of bed and structural rail with which this invention has utility, and showing a trapeze hanging below the rail;

FIG. 3 is a perspective view of a preferred embodiment of a new carriage that is compatible with a structural rail that is mounted over a bed;

FIG. 4 is a perspective view of a rotatable arm that can be mounted on the carriage of FIG. 3 and used to apply a braking force on the adjacent rail;

FIG. 5 is a side elevation view of the carriage of FIG. 3, said view being partially sectioned as indicated by the cutting planes V-V in FIG. 6, and showing the rotatable arm of FIG. 4 installed on the carriage;

FIG. 6 is an elevation view of one end of the carriage, looking along the longitudinal axis of the structural rail;

FIG. 7 is a front elevation view of a trapeze of the type shown in FIG. 2, also sometimes called a medical trapeze—to distinguish it from the kind of trapeze that is used by acrobats in a circus;

FIG. 8 is a perspective view of a sling that could be used to support a patient's broken member (e.g., a leg) while it is healing, said sling depending from a carriage;

FIG. 9 is a perspective view of an alternative embodiment of a carriage, said embodiment omitting wheels but still being movable along the structural rail in response to the application of a modest force in a longitudinal direction;

FIG. 10 is a front elevation view of the carriage shown in FIG. 9, with the bottom of the housing being closed and held around the structural rail by a locking pin;

FIG. 11 is a perspective view of the carriage shown in FIG. 9, with the locking pin being removed and the bottom rotated downward—such that the carriage could be easily connected to a structural rail by slipping it over a side of the rail;

FIG. 12 is a perspective view of a variation of the carriage of FIG. 3 in which a cable hangs below the carriage for a distance such that its lower end might be grasped by a patient who wants to apply or release the brake;

FIG. 13 is a side elevation view of the embodiment of FIG. 12, partially cross-sectioned, showing the connection of a depending cable to the brake-release arm;

FIG. 14 is a perspective view of an alternative embodiment of the carriage, and showing an external lock that can be engaged to hold the latch in one position or the other;

FIG. 15 is a side elevation view of the carriage of FIG. 14;

FIG. 16 is a partially cross-sectioned view of another embodiment of a carriage, wherein the act of pulling down on the carriage's housing will effect a braking action on the rail;

FIG. 17 is a front elevation view of the carriage shown in FIG. 16;

FIG. 18 is a perspective view of another embodiment of a carriage in which a housing can be selectively placed around a structural rail, and spring-loaded spheres can be used to facilitate sliding movement of the carriage along the rail;

FIG. 19 is a cross-sectioned view, in elevation, of the carriage shown in FIG. 18;

FIG. 20 is a perspective view of an alternative embodiment of a carriage in which a housing has an upwardly turned cusp to receive and support the handle of a trapeze, such that the handle can be positioned out of the way when other activities around the bed make the handle temporarily unwanted; and

FIG. 21 is a front elevation view of the handle of a trapeze resting in the cusp-shaped holder on the side of a carriage housing.

### DETAILED DESCRIPTION OF A FIRST EMBODIMENT OF THE INVENTION

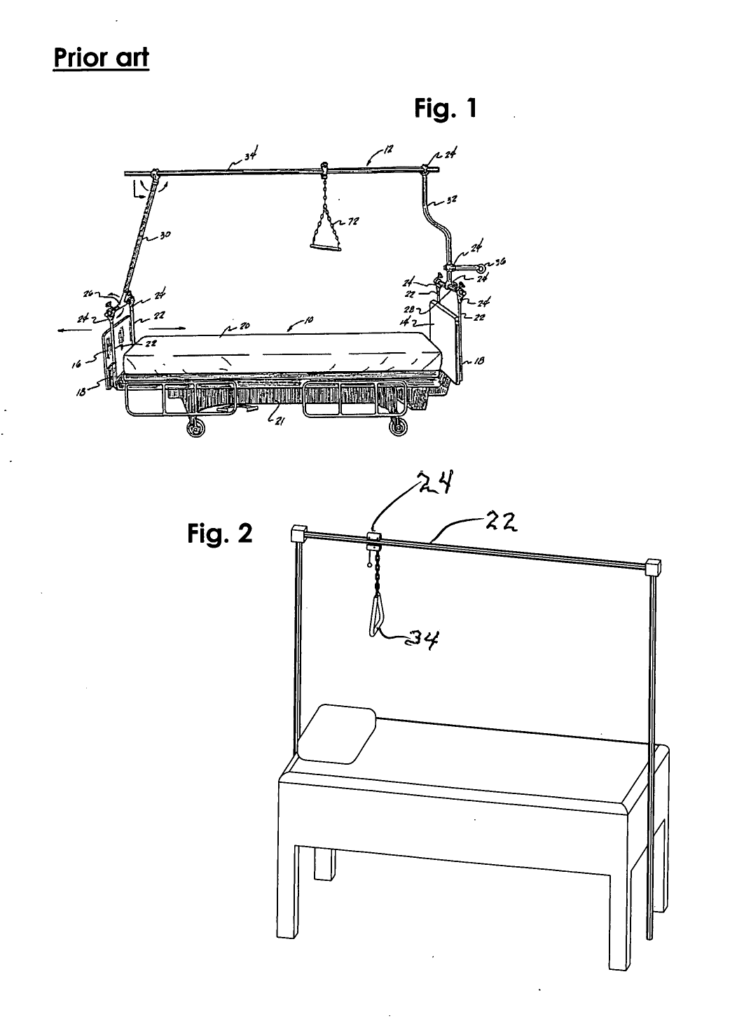

Referring initially to FIG. 1, a bed and a structural rail of the prior art are shown, and a clamp is shown at a typical position along the rail. Such a clamp is held at the spot selected for it, by virtue of manually tightening a bolt or screw around the rail. If a patient wishes to move himself with respect to the bed, he must either wiggle his body or get someone else to position the clamp in an advantage location—so that he might benefit from being able to lift himself by pulling downwardly on a trapeze. Of course, the trapeze 20 is shown with a generally horizontal orientation, suspended below a rail 22 as it is typically employed in modern hospitals. Such a rail 22 has first and second ends and extends longitudinally over a hospital bed—as shown in U.S. Pat. No. 5,836,026 to Reed. The length of the rail 22 is not important to this invention, but there will be a variety of possible positions for a carriage 24 as it slides along the rail. By using a carriage as shown, there will be no need for a hospital to discard any existing rails that are in its inventory. Indeed, there is no need to take apart any existing frame or support over a bed. The preferred carriage has a housing 26 with a side opening 28 that is sized and shaped so that the carriage can be slipped sideways over the rail at essentially any position along the rail.

To set the environment for the disclosure to follow, FIG. 2 again shows a structural rail supported over a horizontal surface, e.g., a bed. A carriage 24 is mounted for sliding movement, in a longitudinal direction, with respect to the structural rail. Relative movement is assured by using one or another of the structural configurations shown herein.

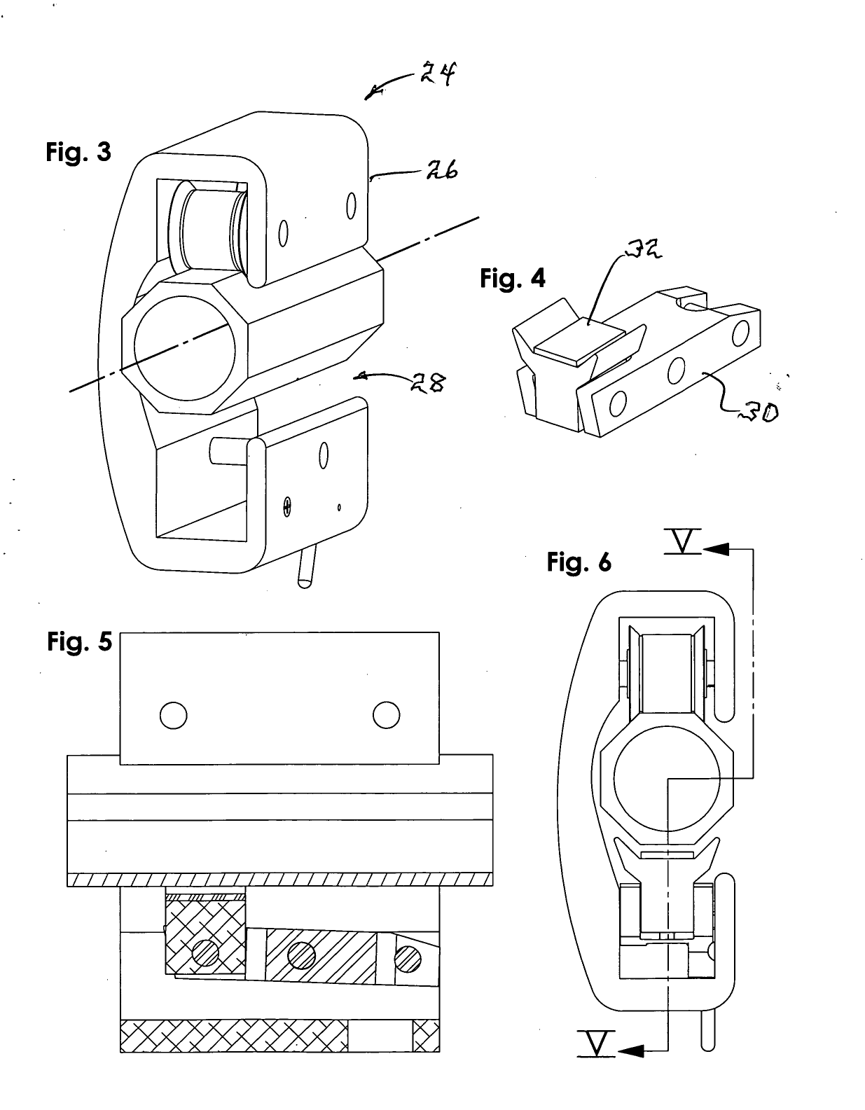

Turning first to FIG. 3, a first carriage 24 has at least one roller mounted near the top of the housing 26, with a side opening 28 that is sized and shaped to permit the housing to slide (sideways) over an adjacent rail 22. In FIG. 4, a pivotable arm 30 is shown alone, i.e., removed from its normal position within the housing. Exposed at the top of the arm 30 is a brake pad 32 that can be rotated upwardly and brought into contact with the bottom of the rail 22, when the opposite end of the arm is pulled down, as it would be when a downwardly directed force is applied to said arm. FIGS. 5 and 6 show other views of this preferred embodiment of a carriage.

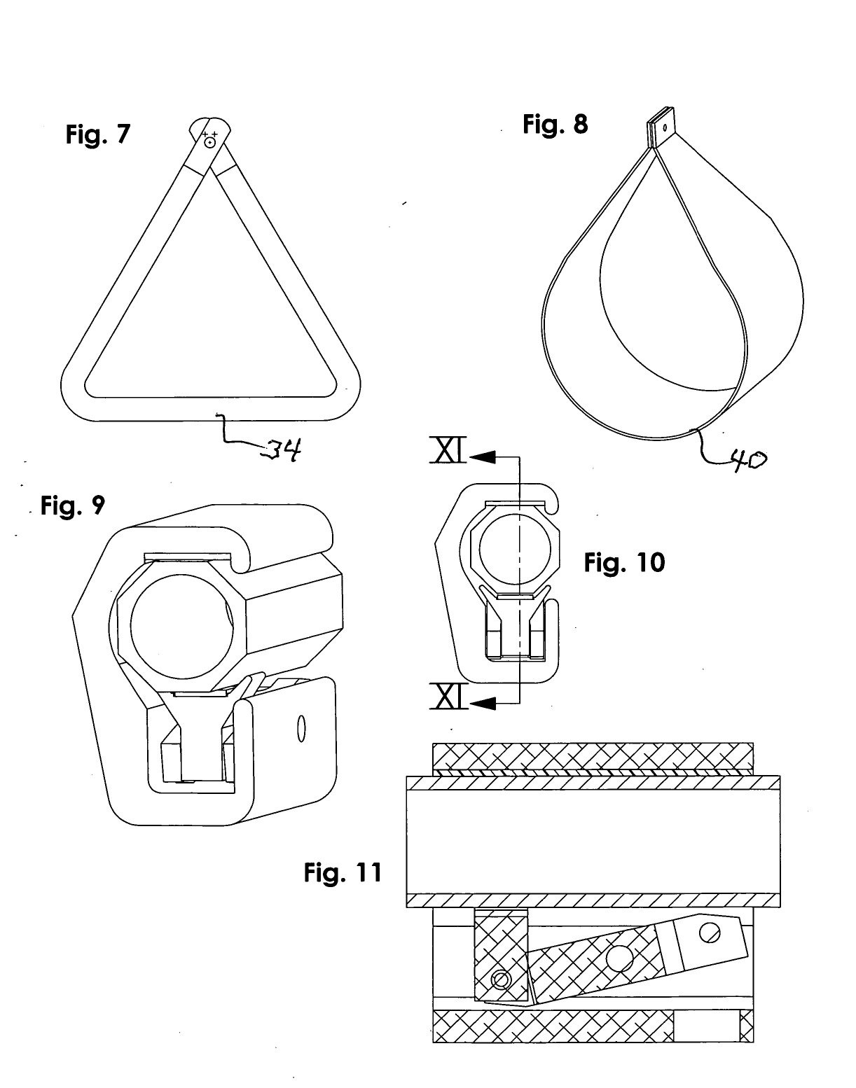

FIG. 7 shows a trapeze, which might aptly be called a “medical trapeze” (to distinguish it from a trapeze that a person might see acrobats use in a circus), with a handle 34 that can be grasped by a patient or a nurse or other care-giver. Another device (shown in FIG. 8) that can be affixed below a carriage is a sling 40 that is shaped and sized so that it might wrap around—and support—a patient's broken leg or the like.

FIGS. 9, 10 and 11 show an alternate embodiment of a carriage, identified by the reference numeral 124. In this embodiment there is a device 131 within the housing 126 that provides low-friction contact with the top of the rail. Such a device 131 replaces the previously described rollers and may be a thin pad of teflon or Kel-F or other low-friction material.

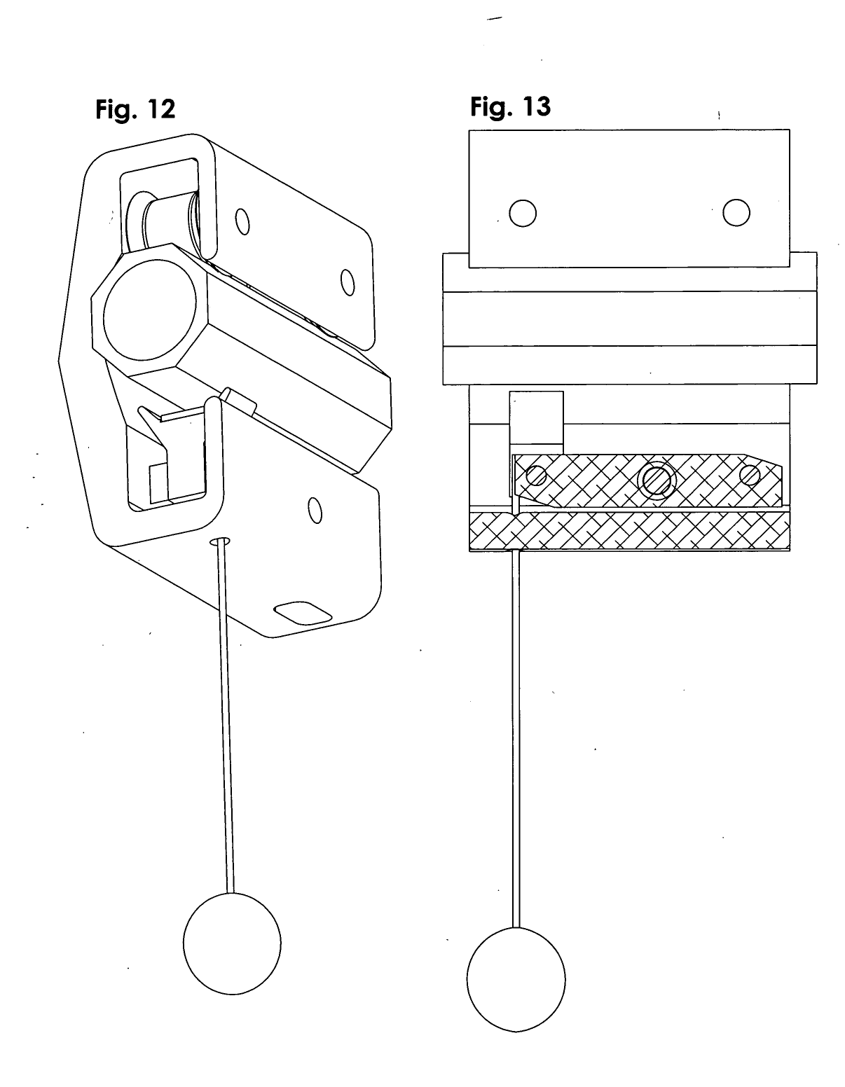

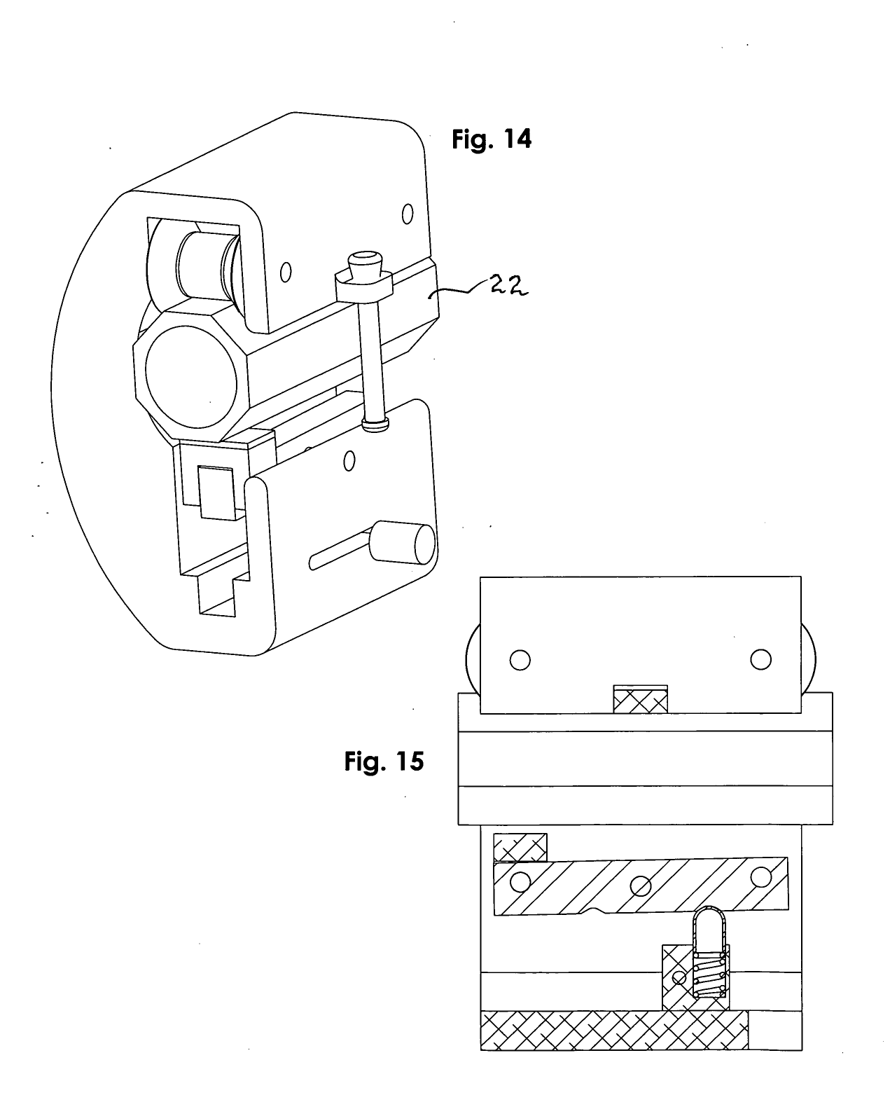

FIGS. 12 and 13 show a variant of a carriage in which a braking action on the carriage (identified by the reference numeral 224) is effected by pulling downward on a cable 241) which causes the brake arm to pivot about its fulcrum. The cable 243 is terminated on its lower end by a rubber-like ball 245, about the size of a golf ball, that can be readily grasped by a person's hand.

FIGS. 14 and 15 show an embodiment in which a locking device 325 is mounted on a carriage 324, said device being contacted by an external knob 327, whose status is readily discernible by a casual inspection. That is, a nurse can quickly determine by walking into a hospital room whether a carriage 324 is fixed or not. Thus, if the patient has a knee problem and his doctor doesn't want the patient to be able to move his knee, he can issue instructions that the carriage 324 be fixed and left alone.

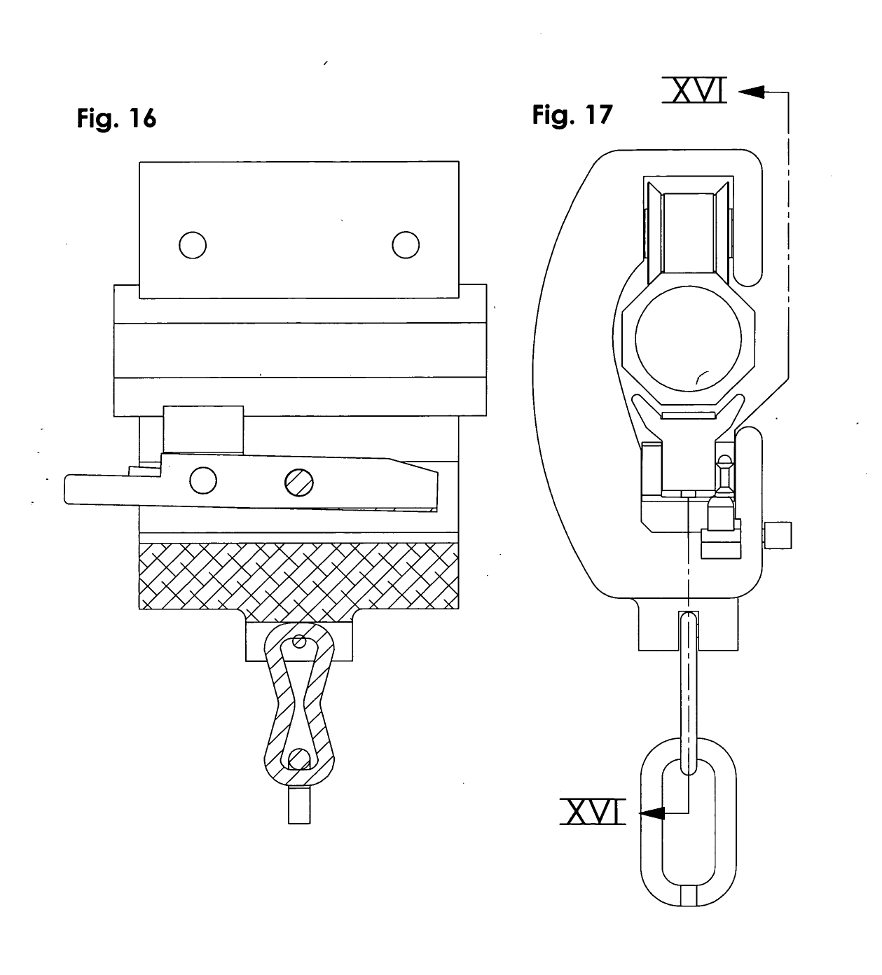

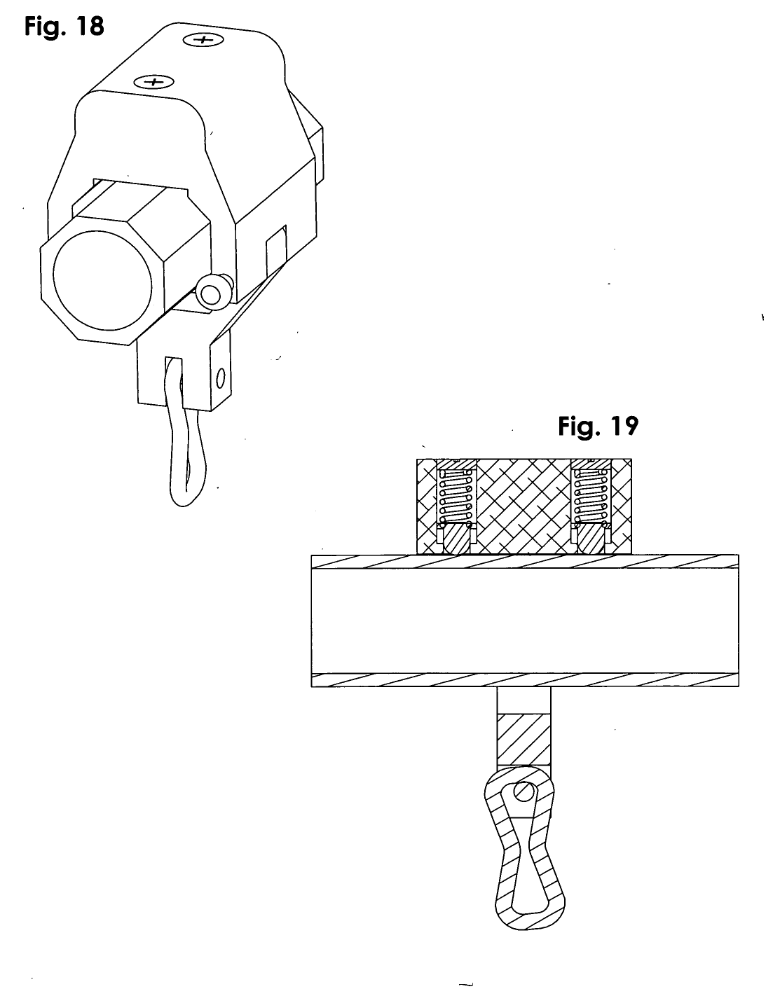

FIGS. 16 and 17 show alternate ways of mounting a carriage on a structural rail, wherein a generally horizontal patient can adjust his position with respect to a supporting bed—by selectively moving a carriage with respect to an overhead rail. Once a desired position has been realized, the carriage can be automatically “fixed” to the rail, and a nurse or other care-giver never has to be involved in the adjustment process.

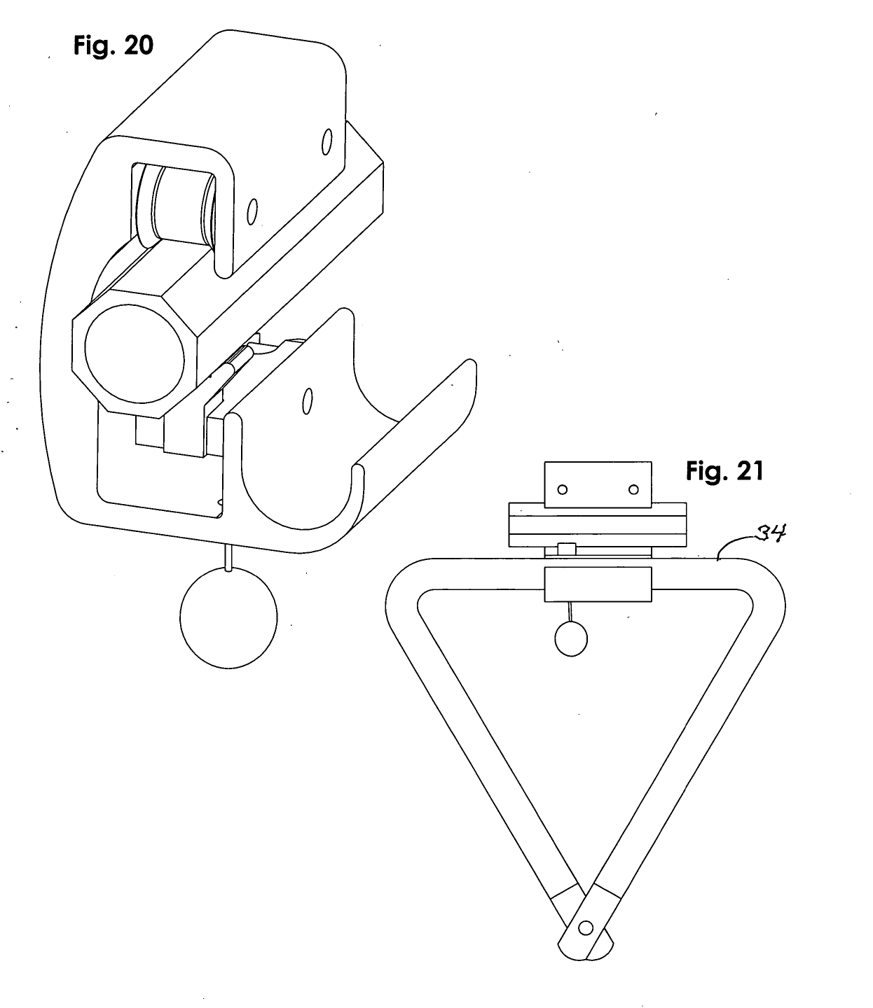

FIGS. 18 and 19 show an alternate embodiment in which two spring-loaded devices in the top of a carriage are provided to facilitate sliding movement of a carriage with respect to a rail. The spring-loaded spheres are a substitute for the previously disclosed wheels in the top of a carriage.

FIG. 20 shows an alternate embodiment of a housing in which a cusp-shaped holder is provided on one side of the carriage. If the trapeze is hanging down where it interferes with constructive work being done (adjacent the bed) by a medical professional, the handle part of the trapeze can simply be lifted up and placed in the holder. FIG. 21 shows a trapeze being supported in what may be described as a storage location.

While several embodiments have been disclosed herein, there may be other features that will occur to those skilled in the art. Hence, the scope of the invention should be measured only by the attached claims.

What is claimed is:

1. In an environment that includes an elongated structural rail that is mounted securely over a bed in which a person is resting in a generally prone position, and further including a carriage that is adapted for selective movement to any one of a variety of positions along the rail, and there being a structural member that depends from the carriage in a downward direction, comprising the method of:
a) establishing a first condition in which the carriage is freely movable with respect to the rail in response to a modest manual force on the carriage in a longitudinal direction; and
b) establishing a second condition in which the carriage is held static with respect to the rail, such that the carriage can function as an anchor to support a person applying a downward force on the carriage, and the change between the first and the second condition being effected by manually applying a downward force on the carriage.

2. The method as claimed in claim 1 wherein the carriage is freely movable with respect to the rail by providing at least one roller between the carriage and the structural rail, and the roller has a periphery that is placed in contact with the structural rail.

3. The method as claimed in claim 1 wherein the downward force is applied to the structural member that depends from the carriage.

4. The method as claimed in claim 1 wherein the structural member that depends from the carriage is a medical trapeze, such that a person resting on the bed can effect a change from one condition to a second condition by the act of pulling downwardly on the medical trapeze.

5. The method as claimed in claim 1 wherein the first condition is one in which the carriage is biased to a freely movable status, and the change to the second condition is automatic when a manual force is applied to the carriage.

6. The method as claimed in claim 1 and including the further step of providing a lock that is effective to prevent a change from one condition to the other condition, and selectively applying the lock to hold the carriage in a fixed condition.

7. A combination having utility for persons who are restricted by injury or illness to a generally prone position for many hours, comprising the combination of:
a) a bed for supporting a person in a generally prone position on top of the bed, and said bed having first and second ends and a longitudinal axis between the two ends;
b) a linear rail extending longitudinally over the bed and extending horizontally from one end of the bed to the other end, and the rail having the structural integrity to support the weight of a person;
c) a carriage having a frame and means for fostering smooth longitudinal movement between the frame and the linear rail;
d) a manually actuated latch carried by the carriage to control relative movement between the carriage's frame and the rail in a longitudinal direction, and the latch having a locking position in which the carriage will not move longitudinally with respect to the rail, and the latch having a second position in which the carriage can be freely moved longitudinally along the rail; and
e) a supporting structure suspended below the carriage's frame, and said supporting structure having the structural integrity to transfer the full weight of a person to the carriage's frame.

8. The combination as described in claim 7 and further including a locking device connected to the latch to render the latch inoperable when it is desired that the carriage be held in a fixed position, whereby a person in authority can decide whether or not the carriage should be permitted to have free relative movement with respect to the rail.

9. The combination as claimed in claim 7 and further including a hand grip that is attached below the frame in order to provide a means for a person resting on the bed to grasp the hand grip and lift himself or herself off the bed by pulling downwardly on the hand grip.

10. The combination as claimed in claim 7 wherein the manually actuated latch is finger-actuated and is located adjacent the lower part of the carriage.

11. The combination as claimed in claim 7 wherein the means for fostering smooth longitudinal movement between the frame and the linear rail constitutes a low-friction strip of material that is mounted interiorly of the carriage and in a location where it will bear against the linear rail.

12. The combination as claimed in claim 7 wherein the means for fostering smooth longitudinal movement of the carriage along the rail constitutes at least one roller that is mounted on the carriage.

13. The combination as claimed in claim 7 and further including a brake pad mounted on the manually actuated latch, and the brake pad being positioned so that it can be selectively brought to bear against the rail.

14. The combination as claimed in claim 7 and further including a cable that has a first end that is connected to the manually actuated latch, and the cable having a second end that extends well below the carriage, whereby a person may grab the second end of the cable and apply a downwardly directed force onto the manually actuated latch.

15. The combination as claimed in claim 14 wherein the second end of the cable is enveloped with a relatively soft material selected from the group that includes plastic and rubber, and having a diameter about the size of a golf ball.

16. The combination as claimed in claim 7 and further including a cusp-shaped holder that is affixed to the housing of a carriage, and the holder having a size and shape to receive and hold a handle of a trapeze.
